(19) United States
(12) Patent Application Publication
(10) Pub. No.: US 2013/0319255 A1
(43) Pub. Date: Dec. 5, 2013

(54) STEAM GENERATOR DEVICE

(71) Applicant: Dick CHIANG, Taichung City (TW)

(72) Inventor: Dick CHIANG, Taichung City (TW)

(21) Appl. No.: 13/484,566

(22) Filed: May 31, 2012

(51) Int. Cl. A47J 37/00; A47J 37/07

(52) U.S. Cl. 99/339; 126/20; 126/25 R

(57) ABSTRACT

A steam generator device has an outer grill and an inner grill. The outer grill has an inner rim, a burner and an injecting hole. The inner rim is formed on and protrudes from an opening top of the outer grill. The injecting hole is formed through the inner rim. The inner grill is mounted in the outer grill between the burner and the outer grill and has a closed bottom and an opening top. The closed bottom of the inner grill is connected to the outer grill to form a water chamber between the outer grill and the inner grill to communicate with the injecting hole. The opening top of the inner grill is mounted in the outer grill below the inner rim to form an annular channel to communicate with the water chamber.

### BACKGROUND OF THE INVENTION

1. Field of the Invention

The present invention relates to a steam generator device, and more particularly to a steam generator device for a fire pit or a barbecue to decrease the temperature of the fire pit or the barbecue, to provide a preferred quality of roast and to increase the moisture of air around the fire pit or the barbecue.

2. Description of Related Art

A conventional barbecue generally comprises a mounting frame and a grill body. The grill body may be hemispherical, is mounted on the mounting frame and has a closed bottom, an opening top, multiple through holes, a water holder and a burner. The through holes are formed through the closed bottom of the grill body at intervals and communicate with the opening top. The water holder is used to store water and is securely connected to the closed bottom of the grill body under the through holes to receive the ashes of the charcoal that fall out of the grill body via the through holes. The burner is mounted in the grill body near the opening top of the grill body.

When the conventional barbecue is used to roast meat, the user needs to pay more attention to prevent meat from searing. After roasting, meat that is roasted on the conventional barbecue may be over-burned or dried and this will influence the mouthfeel of meat. In addition, during the roasting period, the temperature of the grill body of the conventional barbecue is high due to the flaming charcoal to cause people being scalded by the grill body and this is unsafe in use. Furthermore, the air around the barbecue may be dried due to the charcoal fire and people may feel uncomfortable when stand around the conventional barbecue.

To overcome the shortcoming, the present invention provides a steam generator device for a fire pit or a barbecue to obviate or mitigate the aforementioned problems.

### SUMMARY OF THE INVENTION

The main objective of the present invention is to provide a steam generator device for a fire pit or a barbecue to decrease the temperature of the fire pit or the barbecue, to provide a preferred quality of roast and to increase the moisture of air around the fire pit or the barbecue.

A steam generator device in accordance with the present invention has an outer grill and an inner grill. The outer grill has an inner rim, a burner and an injecting hole. The inner rim is formed on and protrudes inwardly from an opening top of the outer grill. The injecting hole is formed through the inner rim of the outer grill. The inner grill is mounted in the outer grill between the burner and the outer grill and has a closed bottom, an opening top and a charcoal net. The closed bottom of the inner grill is securely connected to the outer grill to form a water chamber between the outer grill and the inner grill to communicate with the injecting hole. The opening top of the inner grill is mounted in the outer grill below the inner rim to form an annular channel between the opening top of the inner grill and the inner rim and communicates with the water chamber.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a steam generator device in accordance with the present invention to serve as a barbecue;

FIG. 2 is an exploded perspective view of the steam generator device in FIG. 1;

FIG. 3 is a partially and enlarged perspective view in partial section of the steam generator device in FIG. 1;

FIG. 4 is another partially and enlarged perspective view in partial section of the steam generator device in FIG. 1;

FIG. 5A is an enlarged side view in partial section of the steam generator device in FIG. 1;

FIG. 5B is an enlarged side view in partial section of the steam generator device in FIG. 5A; and

FIG. 6 is an operational perspective view in partial section of the steam generator device in FIG. 1 to serve as a fire pit.

### DETAILED DESCRIPTION OF THE PREFERRED EMBODIMENT

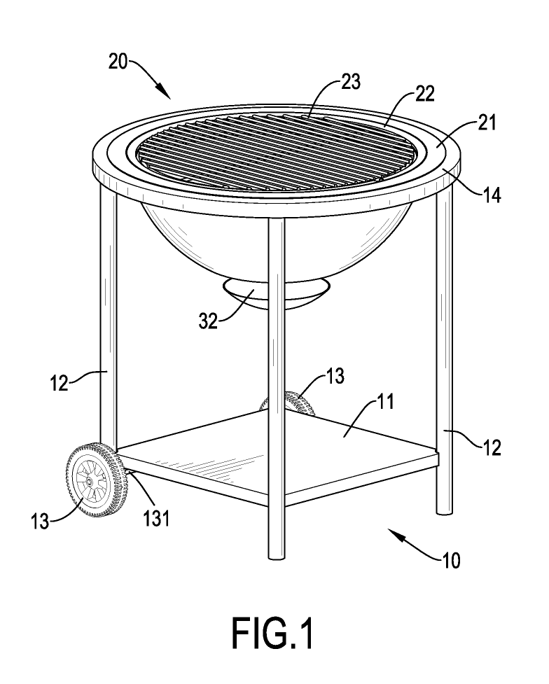

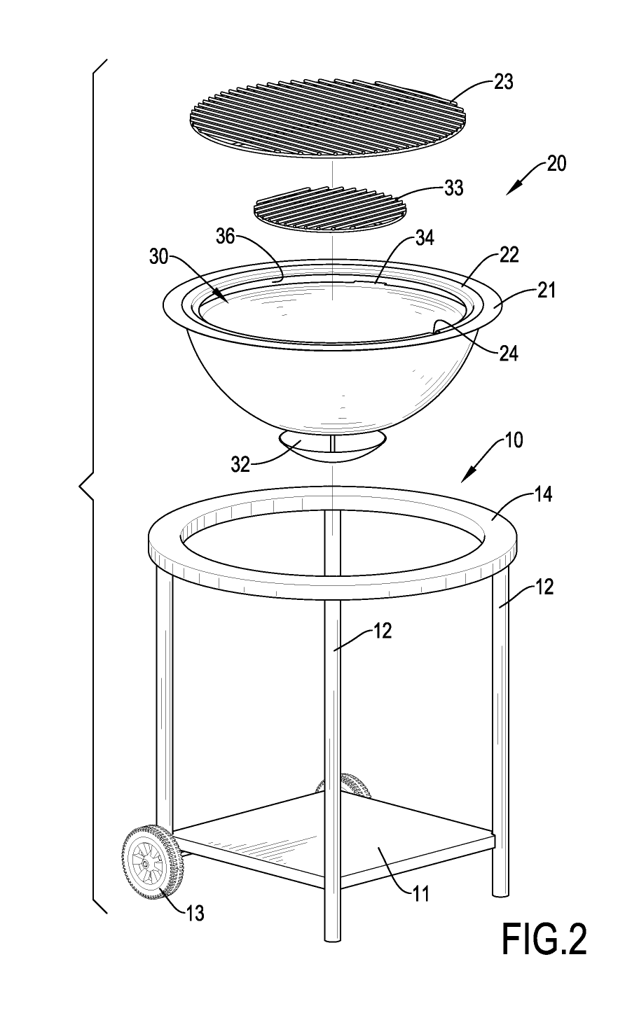

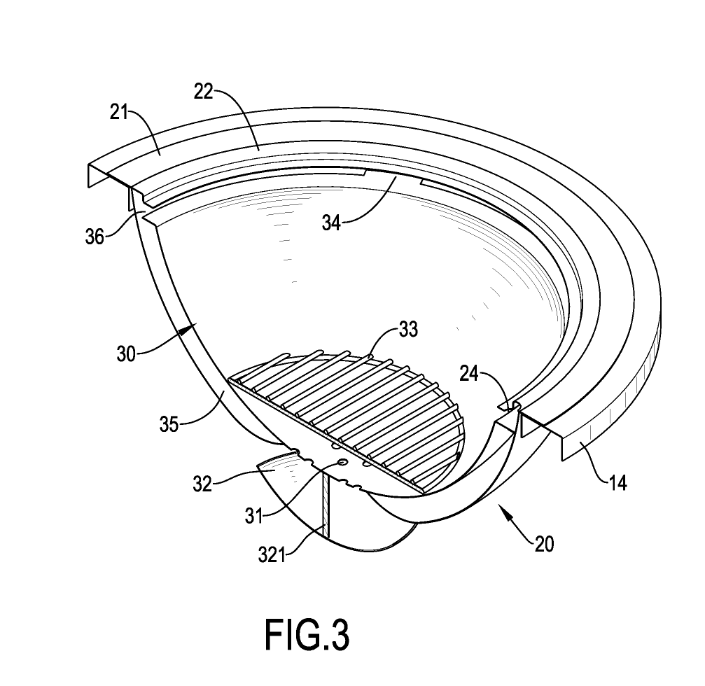

With reference to FIGS. 1 to 3, a steam generator device in accordance with the present invention can be served as a fire pit or a barbecue and comprises a mounting frame 10, an outer grill 20 and an inner grill 30.

The mounting frame 10 has a bottom panel 11, four supporting legs 12, two wheels 13 and a holding mount 14. The bottom panel 11 may be quadrate and has four corners. The supporting legs 12 are respectively connected to the corners of the bottom panel 11 and protrude upwardly from the bottom panel 11, and each supporting leg 12 has a top end and a bottom end. The wheels 13 are rotatably mounted on two of the supporting legs 12 with a wheel axle 131 near the bottom ends of the two corresponding supporting legs 12. Then, the steam generator device can be moved easily with the wheels 13. The holding mount 14 is annular and is securely mounted on the top ends of the supporting legs 12.

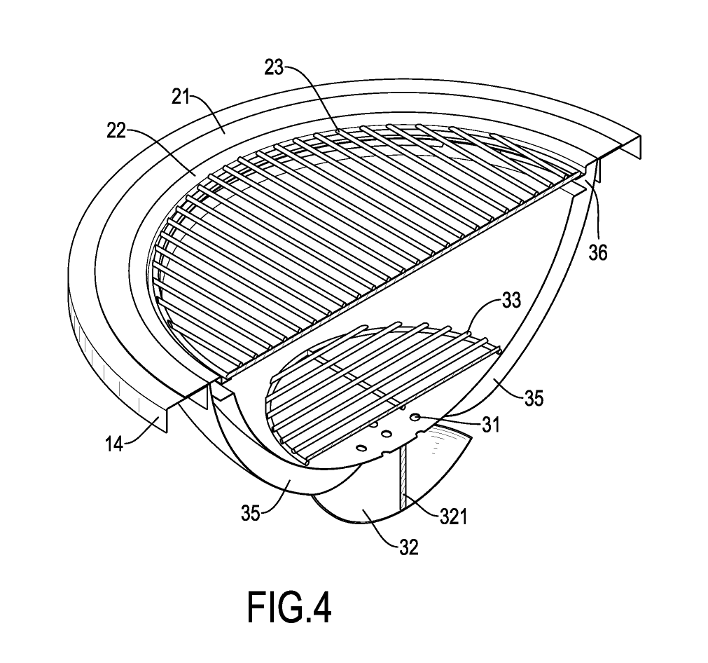

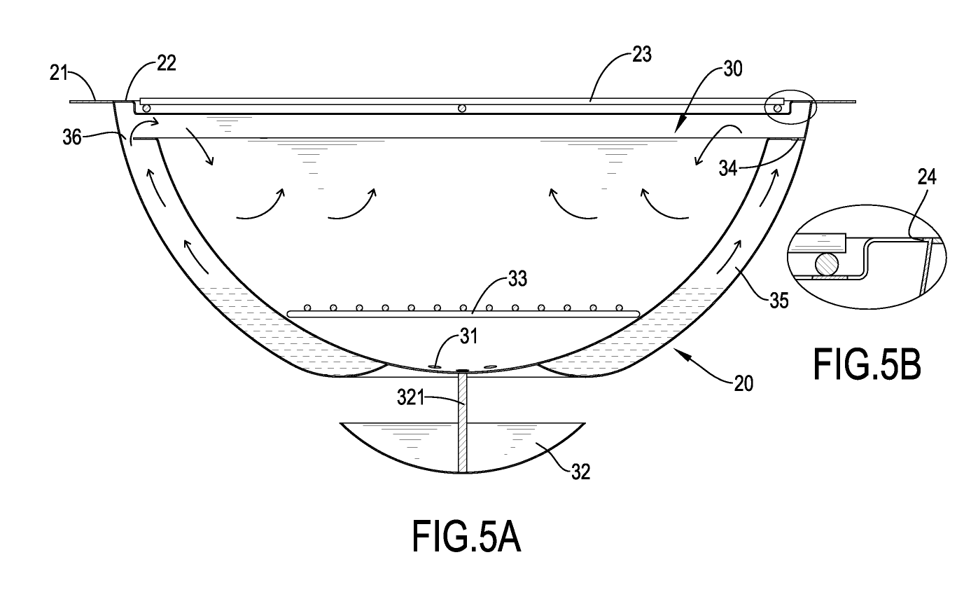

With further reference to FIGS. 4 and 5A, the outer grill 20 is detachably mounted on the holding mount 14 of the mounting frame 10 above the bottom panel 11 and has a closed bottom, an opening top, an open mouth, an internal surface, a holding flange 21, an inner rim 22 and an injecting hole 24. The open mouth is formed through the closed bottom of the outer grill 20. The holding flange 21 is formed around the opening top of the outer grill 20 and abuts the holding mount 14 to enable the outer grill 20 to be held above the bottom panel 11 of the mounting frame 10. The inner rim 22 is formed on and protrudes inwardly from the opening top of the outer grill 20 and is connected to the holding flange 21. The injecting hole 24 is formed through the inner rim 22 of the outer grill 20. A burner 23 is detachably mounted on and abuts the inner rim 22 above the closed bottom of the outer grill 20 to hold meat, such that the steam generator device can serve as a barbecue.

The inner grill 30 is mounted in the outer grill 20 between the burner 23 and the closed bottom of the outer grill 20 and has a closed bottom, an opening top, multiple though holes 31, a water holder 32, a charcoal net 33 and at least one connecting wing 34. The closed bottom of the inner grill 30 is securely connected to the closed bottom of the outer grill 20 and a portion of the closed bottom of the inner grill 30 extends out of the closed bottom of the outer grill 20 via the open mouth of the outer grill 20 to form a water chamber 35 between the outer grill 20 and the inner grill 30 to communicate with the injecting hole 24 of the outer grill 20. The opening top of the inner grill 30 is mounted in the outer grill 20 below the inner rim 22 of the outer grill 20 to form an annular channel 36 between the opening top of the inner grill 30 and the inner rim 22 of the outer grill 20. The annular channel 36 communicates with the water chamber 35.

The through holes 31 are formed through the portion of the closed bottom of the inner grill 30 that extends out of the closed bottom of the outer grill 20 and are separately from each other. The water holder 32 is securely connected to the portion of the closed bottom of the inner grill 30 that extends out of the closed bottom of the outer grill 20 under the through holes 31 by a connecting rod 321. The charcoal net 33 is mounted in the inner grill 30 near the closed bottom of the inner grill 30 under the burner 23 to hold charcoal. The at least one connecting wing 34 is radially formed on and protrudes from the opening top of the inner grill 20 and is connected to or abuts the internal surface of the outer grill 30 to hold the inner grill 30 securely in the outer grill 20.

With reference to FIGS. 5A and 5B, in use, water is mounted into the water chamber 35 between the grills 20, 30 before roasting via the injecting hole 24. When water is held in the water chamber 35, charcoal is putted on the charcoal net 33. Accordingly, water in the water chamber 35 will be heated by charcoal to evaporate into steam and the steam will flow out of the steam generator device via the annular channel 36 and the burner 23. When a burner 23 is mounted on the inner rim 22 and meat is putted on the burner 23, the steam generator device can serve as a barbecue. During the roasting period, the steam flows out of the steam generator device via the annular channel 36 and the burner 23, the steam will go into the meat that is putted on the burner 23 to make the meat more juicy and taste much better in chewing and to prevent the meat from being over-burned and dried. Furthermore, when the steam flows in the inner grill 30 via the annular channel 36, the charcoal fire will provide a suction force to the steam to enable the steam to flow inwardly the inner grill 30. Then, the steam can flow out of the steam generator device via whole of the burner 23 and the steam generator device in accordance with the present invention can provide a preferred quality of roast in use.

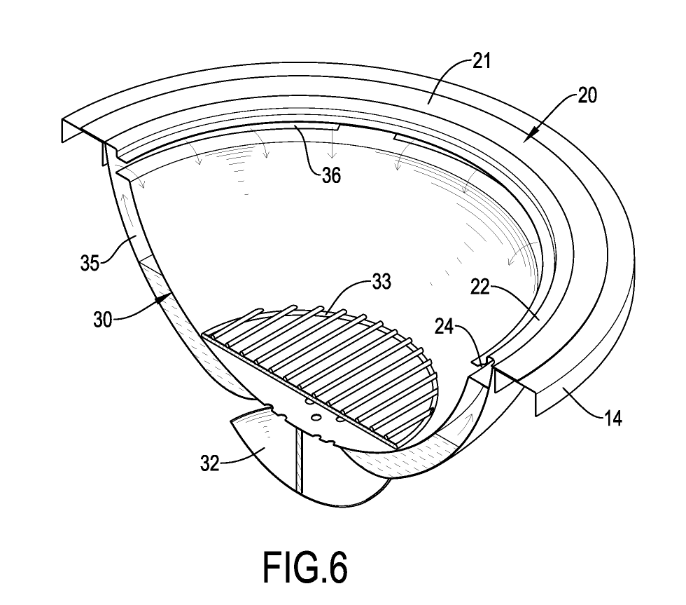

In addition, with reference to FIG. 6, the steam generator device in accordance with the present invention can serve as a fire pit. At this time, water in the water chamber 35 also can be used to decrease the temperature of the grills 20, 30 of the steam generator device for a fire pit and this can prevent people from being scalded by the grills 20, 30. Furthermore, the steam that flows out of the steam generator device for a fire pit also can be used to increase the moisture of air around the steam generator device for a fire pit. Then, people will feel comfortable when stand around the steam generator device for a fire pit in accordance with the present invention. Additionally, the user also can drop an essential oil into water that is filled in the water chamber 35 to increase the aroma of air around the steam generator device for a fire pit.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A steam generator device having
an outer grill having
a closed bottom;
an opening top;
an open mouth formed through the closed bottom of the outer grill;
an internal surface;
an inner rim formed on and protruding inwardly from the opening top of the outer grill; and
an injecting hole formed through the inner rim of the outer grill; and
an inner grill mounted in the outer grill between the burner and the closed bottom of the outer grill and having
a closed bottom securely connected to the closed bottom of the outer grill and a portion of the closed bottom of the inner grill extending out of the closed bottom of the outer grill via the open mouth of the outer grill to form a water chamber between the outer grill and the inner grill to communicate with the injecting hole of the outer grill; and
an opening top mounted in the outer grill 0 below the inner rim of the outer grill to form an annular channel between the opening top of the inner grill and the inner rim of the outer grill and communicating with the water chamber.

2. The steam generator device as claimed in claim 1, wherein
the steam generator device has a mounting frame and the mounting frame has
four supporting legs, and each supporting leg having a top end; and
a holding mount being annular and securely mounted on the top ends of the supporting legs; and
the outer grill is detachably mounted on the holding mount of the mounting frame and has
a holding flange formed around the opening top of the outer grill, connected to the inner rim and abutting the holding mount to enable the outer grill to be held above the bottom panel of the mounting frame; and
a burner detachably mounted on and abutting the inner rim above the closed bottom of the outer grill.

3. The steam generator device as claimed in claim 2, wherein
each one of the supporting legs has a bottom end; and
the mounting frame has
a bottom panel connected to the supporting legs near the bottom end of the supporting legs under the outer grill; and
two wheels rotatably mounted on two of the supporting legs with a wheel axle near the bottom ends of the two corresponding supporting legs.

4. The steam generator device as claimed in claim 3, wherein the inner grill 30 has
a charcoal net mounted in the inner grill near the closed bottom of the inner grill;
multiple through holes formed through the portion of the closed bottom of the inner grill that extends out of the closed bottom of the outer grill; and
a water holder securely connected to the portion of the closed bottom of the inner grill that extends out of the closed bottom of the outer grill under the through holes by a connecting rod.

5. The steam generator device as claimed in claim 4, wherein the inner grill has at least one connecting wing radially formed on and protruding from the opening top of the inner grill and connected to the internal surface of the outer grill to hold the inner grill securely in the outer grill.

6. The steam generator device as claimed in claim 1, wherein the inner grill has
a charcoal net mounted in the inner grill near the closed bottom of the inner grill;
multiple through holes formed through the portion of the closed bottom of the inner grill that extends out of the closed bottom of the outer grill; and
a water holder securely connected to the portion of the closed bottom of the inner grill that extends out of the closed bottom of the outer grill under the through holes by a connecting rod.

7. The steam generator device as claimed in claim 1, wherein the inner grill has at least one connecting wing radially formed on and protruding from the opening top of the inner grill and connected to the internal surface of the outer grill to hold the inner grill securely in the outer grill.

8. The steam generator device as claimed in claim 2, wherein the inner grill has
a charcoal net mounted in the inner grill near the closed bottom of the inner grill;
multiple through holes formed through the portion of the closed bottom of the inner grill that extends out of the closed bottom of the outer grill; and
a water holder securely connected to the portion of the closed bottom of the inner grill that extends out of the closed bottom of the outer grill under the through holes by a connecting rod.

9. The steam generator device as claimed in claim 2, wherein the inner grill has at least one connecting wing radially formed on and protruding from the opening top of the inner grill and connected to the internal surface of the outer grill to hold the inner grill securely in the outer grill.

10. The steam generator device as claimed in claim 3, wherein the inner grill has at least one connecting wing radially formed on and protruding from the opening top of the inner grill and connected to the internal surface of the outer grill to hold the inner grill securely in the outer grill.
